(19) United States
(12) Patent Application Publication
(10) Pub. No.: US 2026/0366459 A1
(43) Pub. Date: Nov. 19, 2026

(54) ASSEMBLY PROVIDED WITH A MULTILAYER COVER STRIP FOR CONNECTING AN EXHAUST NOZZLE TO A HEAT EXCHANGER

(71) Applicant: AIRBUS HELICOPTERS, Marignane Cedex (FR)

(72) Inventors: Olivier HONNORAT, Aix En Provence (FR); Jonathan RANAIVOSON, Marseille (FR); Christophe DUBOURG, Le Tholonet (FR)

(73) Assignee: AIRBUS HELICOPTERS, Marignane Cedex (FR)

(21) Appl. No.: 19/568,147

(22) Filed: Mar. 16, 2026

(30) Foreign Application Priority Data
May 15, 2025 (FR) FR2505177

(51) Int. Cl. F02C 7/10; B64D 27/10; B64D 33/02

(52) U.S. Cl. CPC F02C 7/10; B64D 27/10; B64D 33/02; B64D 2033/0253; F05D 2260/20

(57) ABSTRACT

A heat exchange assembly comprising an exhaust nozzle supplying hot gases to a heat exchanger, the exhaust nozzle extending to an outlet end section, the heat exchanger comprising an inlet end section. The outlet end section enters the inlet end section in order to form a baffle with respect to the hot gases; the heat exchange assembly comprising a multilayer cover strip secured to a first angle bracket connected to the exhaust nozzle, the multilayer cover strip being secured to a second angle bracket connected to the heat exchanger, the multilayer cover strip surrounding the inlet end section and the outlet end section.

### CROSS REFERENCE TO RELATED APPLICATION

This application claims the benefit of FR 25 05177 filed on May 15, 2025, the disclosure of which is incorporated in its entirety by reference herein.

### TECHNICAL FIELD

The present disclosure relates to an assembly provided with a multilayer cover strip for connecting an exhaust nozzle to a heat exchanger. The present disclosure is in the field of heat exchangers, and in particular heat exchangers intended for heating the compressed air used as an oxidizer in a combustion chamber of a gas turbine fitted to an aircraft.

### BACKGROUND

The disclosure also relates to a power plant provided with a gas turbine and this assembly. The disclosure also relates to an aircraft, such as a rotorcraft powered by one or more such gas turbines.

A gas turbine comprises a gas generator supplied with fresh air. This gas generator is provided with a compressor having one or more compression stages, for example of the centrifugal compressor type, for compressing the air coming from the outside. The compressed air is then directed into a combustion chamber of the gas generator. Exhaust gases then exhaust from the combustion chamber to set in motion at least one high-pressure turbine of the gas generator constrained to rotate with the one or more compressors. In addition, the exhaust gases can then set in motion at least one low-pressure free turbine that is constrained to rotate with a power shaft. The exhaust gases are then directed towards an environment external to the aircraft via an exhaust nozzle.

The efficiency of a gas turbine can be improved by heating the air compressed by the compressor before it is admitted into the combustion chamber.

For this purpose, the power plant may comprise a heat exchanger for heating the air compressed by the compressor, by means of the exhaust gases.

For this purpose, a known heat exchanger comprises a plate heat exchange unit arranged in a casing. The heat exchange unit comprises a stack of modules, each module comprising two plates. The casing is mechanically connected to the exhaust nozzle and to an outlet nozzle. Consequently, the heat exchange unit is in fluid communication firstly with the compressor and secondly with the combustion chamber. As a result, the compressed air exiting the compressor circulates in the heat exchange unit, passing inside each module between the two plates of each module, and then exits the heat exchange unit to reach the combustion chamber. Conversely, the exhaust gases coming from the exhaust nozzle penetrate into the heat exchanger, then reach the outlet nozzle passing, in particular, between the modules in order to heat the compressed air.

Documents FR 2988822 and FR 3024225 describe, for example, a heat exchanger comprising a plurality of plates associated in pairs. Each plate has a multitude of parallel corrugations and two chimneys that, when grouped together, form inlet and outlet pipes of the exchanger. The plates of these exchangers have a low thickness and are made of Inconel®.

Within an aircraft, such a heat exchanger is subjected to very high thermal and mechanical stresses.

More specifically, the exhaust gases leaving a turboshaft engine are extremely hot, of the order of 700 °C (degrees Celsius). The elements constituting the heat exchanger must be capable of withstanding such temperatures. Moreover, when the engine is started, a very large and rapid temperature variation is produced within the heat exchanger, with a change from an ambient temperature, for example in the order of 15 °C, to 700 °C in about ten seconds. This sudden increase in temperature, due to the engine starting sequence, then induces very high thermal and mechanical stresses capable of generating non-negligible deformations of the heat exchanger.

In order to take into account the expansion of the heat exchanger, the heat exchanger casing can be fastened to the exhaust nozzle by a bellows. Nevertheless, the conditions of use may make the dimensioning of such a bellows difficult, due in particular to the pressure and temperature that they experience and the significant expansions of the heat exchanger in particular.

Documents JP 2003 227312 A, U.S. Pat. No. 4,090,358, FR 3 142 221 A1 and U.S. 2015/284074 A1 are also known.

### SUMMARY

An object of the present disclosure is therefore to provide an innovative device that can link a heat exchanger to an exhaust nozzle.

Thus the disclosure proposes a heat exchange assembly comprising an exhaust nozzle supplying hot gases to a heat exchanger, the exhaust nozzle extending to an outlet end section delimiting a first volume through which said hot gases exhaust to reach the heat exchanger, the heat exchanger comprising an inlet end section delimiting a second volume through which the hot gases penetrate into the heat exchanger, the outlet end section and the inlet end section extending 360 degrees around a longitudinal axis.

In addition, the outlet end section enters the inlet end section in order to form a baffle with respect to said hot gases; a space radially separating the outlet end section and the inlet end section, said heat exchange assembly comprising a multilayer cover strip secured to a first angle bracket that is secured to the exhaust nozzle, the multilayer cover strip being secured to a second angle bracket that is secured to the heat exchanger, the multilayer cover strip surrounding the inlet end section and the outlet end section.

Consequently, the insertion of the exhaust nozzle into the heat exchanger tends to limit the circulation of hot exhaust gases to the outside by a baffle effect.

In addition, this feature enables a lining to be obtained, that reduces the separation regions of the fluid and consequently the friction losses.

The baffle thus has a limited impact on the flow of hot gases from the exhaust nozzle to the heat exchanger, since this exhaust nozzle penetrates into the heat exchanger.

In addition, these features make it possible to maintain a substantially smooth pipe even when the heat exchanger tends to enter the exhaust nozzle by, for example, of order 5 to 6 mm, following expansion in a longitudinal direction. The flow of exhaust gases is not disturbed, or is only slightly disturbed, as a result of this expansion because the aerodynamic shape of the region remains unchanged.

In particular, the inlet end section may overlap the outlet end section over a length of at least 10 mm, or even 15 mm. Such a length may indeed prove sufficient to compensate for an expansion causing a deformation of the heat exchanger of order 5-6 mm.

According to another aspect, the space present between the inlet end section and the outlet end section is defined to avoid contact between this inlet end section and this outlet end section. This space may extend, radially along the longitudinal axis, over a height of order 5 mm for example.

In addition, this baffle opens onto a volume that is longitudinally delimited by the first angle bracket and the second angle bracket, and radially delimited by the multilayer cover strip. Consequently, this arrangement enables pressure drops to be generated limiting a flow to the outside. The exhaust nozzle, the heat exchanger, the first angle bracket, the second angle bracket, and the multilayer cover strip together tend to form a connection device that is substantially impermeable to the hot gases flowing through the exhaust nozzle and the heat exchanger.

In addition, the multilayer cover strip comprises a stack of layers. Such a multilayer cover strip is sufficiently flexible and elastic to tolerate deformations of the exhaust nozzle and/or of the heat exchanger in all directions in operation, namely in the longitudinal direction of movement of the exhaust gases and in two directions perpendicular to this longitudinal direction, or may also allow slight rotations with respect to these three directions. The multilayer cover strip can thus make it possible to prevent transmission of force between the exhaust nozzle and the heat exchanger, the exhaust nozzle and the heat exchanger being functionally independent of one another. Thus, the multilayer cover strip enables the vibrations and expansions to which the exhaust nozzle and the heat exchanger are subject to be absorbed. In addition, such a multilayer cover strip can withstand the high temperatures and pressure experienced in operation.

Consequently, the exhaust nozzle, the heat exchanger, the first angle bracket, the second angle bracket and the multilayer cover strip together tend to form a connection device that is relatively simple, lightweight, thermally and mechanically resistant and substantially impermeable to the exhaust gases. Moreover, the multilayer cover strip can be easily replaced in the event of degradation.

This heat exchange assembly may also comprise one or more of the following features, taken individually or in combination.

Thus, the first angle bracket may extend along a first closed line around said longitudinal axis and the second angle bracket extending along a second closed line around said longitudinal axis.

The angle brackets are continuous in order to optimize the impermeability.

According to one possibility compatible with the preceding possibilities, the multilayer cover strip can be attached at least to the first angle bracket or to the second angle bracket by screws.

Securing by screws is effective for fastening the multilayer cover strip to an angle bracket.

Optionally, at least one clamping collar can clamp the multilayer cover strip to at least one of the first angle bracket and second angle bracket.

This feature has the non-negligible advantage of not requiring the relevant angle bracket to be drilled in order to attach the multilayer cover strip.

In this case and in the presence of a corresponding polygonal end section, the attachment angle bracket can extend in a radial direction from an inner face to an outer face, the inner face describing a polygon and adjoining the exhaust nozzle or to the heat exchanger, the outer face being curved and adjoining the clamping collar.

According to one possibility compatible with the preceding possibilities, the multilayer cover strip is wound on itself around said longitudinal axis.

In other words, said multilayer cover strip extends more than 360 degrees around said longitudinal axis by being folded on itself. The cover strip may describe more than one turn around the longitudinal axis. Thus, the multilayer cover strip completely covers the volume separating the first angle bracket from the second angle bracket.

For example, the multilayer cover strip successively comprises a first end region, a central region and a second end region, the first end region and the central region each being placed on the first angle bracket and the second angle bracket, the second end region covering at least the first end region.

According to one possibility compatible with the preceding possibilities, the multilayer cover strip may comprise a stack of layers comprising a plurality of first layers, the stack resting on the first angle bracket and the second angle bracket, each first layer comprising silica, said stack comprising a second layer that is at least partially metallic.

In particular, the silica-based first layers make it possible to optimize the thermal resistance of the multilayer cover strip. These silica-based first layers may comprise fabrics having silica mineral fibers.

Moreover, the number of first layers can be determined in order to obtain the desired level of impermeability. The more first layers there are, the more impermeable is the cover strip.

The metal layer provides the required mechanical strength, and can reinforce the impermeability of the cover strip. The metal layer is advantageously very thin, for example having a thickness of between 10 microns and 30 microns. Such a thickness makes it possible to impart sufficient flexibility to the cover strip in order to tolerate, in particular, the deformations of the heat exchanger during operation.

Consequently, the cover strip may be resistant and elastic, and may be relatively flexible and lightweight.

Optionally, the second layer is disposed between two first layers.

For example, the second layer represents the penultimate layer of the stack of the cover strip, a single first layer separating the second layer from an external environment.

The second layer is very thin and bonded to silica layers. The second layer may then be placed within the stack of the cover strip, for example in the penultimate position. Such an arrangement makes it possible to prevent the second layer from being torn during the placing of the cover strip by an operator or during operation, for example. Moreover, the second layer, trapped in the stack of the cover strip, can undergo more deformations without tearing, by eliminating a skin effect that generates more shear in the outer skin.

Optionally, the second layer may comprise a metal mesh or a metal sheet, the second layer being made of aluminum alloy or stainless steel.

In particular, the second layer may comprise a stainless steel mesh or aluminum alloy sheet. A metal foil has the advantage of reinforcing the impermeability of the cover strip.

According to one possibility compatible with the preceding possibilities, each first layer may have a thickness of order 0.3 mm, and the second layer may have a thickness of order 0.02 mm.

According to one possibility compatible with the preceding possibilities, the stack of the cover strip may comprise at least about ten first layers.

According to one possibility compatible with the preceding possibilities, the outlet end section and the inlet end section may each have a polygonal shape.

For example, the output end section and the input end section are homothetic, being of the same shape but of different dimensions.

According to one possibility compatible with the preceding possibilities, said heat exchange assembly may comprise at least one sealing strip arranged longitudinally between the first angle bracket and the second angle bracket, said at least one sealing strip being arranged radially with respect to the longitudinal axis in a volume lying between the inlet end section and the multilayer cover strip.

In particular, the one or more optional sealing strips can limit the risk of hot gases leaking to the outside.

Optionally, since the outlet end section and the inlet end section may each be polygonal in shape and have the same number of sides, said heat exchange assembly may comprise at least one sealing strip per side of the inlet end section, at least one sealing strip being arranged between each side of the inlet end section and the multilayer cover strip.

For example, the exhaust nozzle has four sides facing four sides of the heat exchanger. Between each side of the heat exchanger and the multilayer cover strip, this system may comprise at least one sealing strip depending on the available volume and the thickness of the sealing strip.

According to one possibility compatible with the preceding possibilities, each sealing strip may comprise a stack comprising insulating layers comprising silica, at least one sealing strip having a stack comprising insulating layers covering an inner layer comprising vermiculite facing the inlet end section.

Each sealing strip may comprise the same types of fabrics as the multilayer cover strip, or even a layer of vermiculite and/or a metal layer disposed in the stack of insulating layers. This layer of vermiculite provides thermal protection for the sealing strip.

In the presence of a plurality of sealing strips disposed one on top of the other, it is possible to place the vermiculite layer only on the sealing strip closest to the inlet end section, the other sealing strip or strips having only the stack of insulating layers, for example.

According to one possibility compatible with the preceding possibilities, said heat exchanger may comprise a casing housing a plate heat exchange unit, the casing comprising said inlet end section.

According to another aspect, a power plant, comprising an engine provided with a compressor and a combustion chamber, comprises a heat exchange assembly according to the disclosure of the type described above, the exhaust nozzle being in fluid communication with the engine and receiving hot gases emitted by said combustion chamber, said heat exchanger being in fluid communication with the compressor in order to receive compressed air and to heat it using said hot gases before returning them to said combustion chamber.

The disclosure also relates to an aircraft comprising such a power plant.

### BRIEF DESCRIPTION OF THE DRAWINGS

The disclosure and its advantages appear in greater detail from the following description of examples given by way of illustration with reference to the accompanying figures, wherein:

FIG. 1 is a schematic view of an aircraft provided with a power plant of the disclosure;

FIG. 2 is a side-view of a power plant according to the disclosure;

FIG. 3 is a longitudinal sectional view of a heat exchange assembly according to the disclosure;

FIG. 4 is a partial sectional view of the multilayer cover strip of FIG. 3;

FIG. 5 is a diagram illustrating a clamping collar attachment of a multilayer cover strip;

FIG. 6 is a diagram illustrating a domed angle bracket;

FIG. 7 is a diagram illustrating the layers of a multilayer cover strip;

FIG. 8 is a diagram illustrating the layers of a multilayer cover strip;

FIG. 9 is a radial sectional view of a heat exchange assembly of the disclosure; and

FIG. 10 is a diagram illustrating the layers of a sealing strip.

### DETAILED DESCRIPTION

Elements present in more than one of the figures are given the same references in each of them.

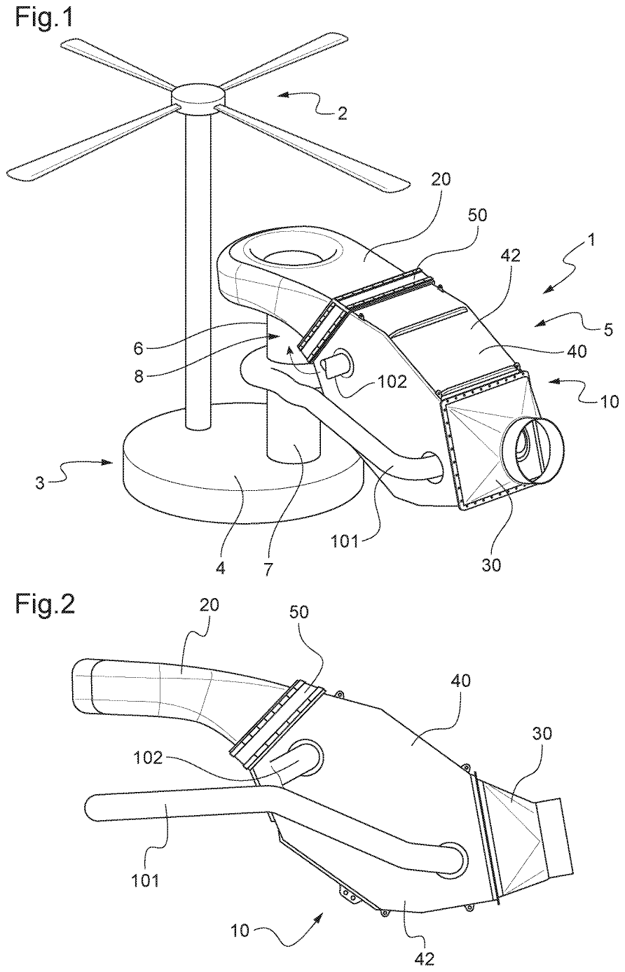

FIG. 1 shows a heat exchange assembly 10 arranged within a power plant 5, and in particular for powering an aircraft 1.

According to the illustrated example, the engine 6 can set in motion at least one rotor 2 via a power transmission chain. For example, the engine 6 comprises a power shaft setting in motion a power transmission gearbox 4 of the power transmission chain, this power transmission gearbox setting the rotor 2 in rotation.

The engine 6 may be a turboshaft engine comprising a compressor 7 for conveying compressed air to a combustion chamber 8. The hot exhaust gases generated by the combustion chamber 8 are more simply referred to as “hot gases”. These hot gases then pass through at least one high-pressure expansion turbine secured to the compressor 7, or a low-pressure expansion turbine setting in motion the power shaft according to the example shown, and then exhausting from the engine 6.

To improve the efficiency of the engine 6, the power plant 5 can therefore comprise a heat exchange assembly 10 according to the disclosure, comprising an exhaust nozzle 20 and a heat exchanger 40 located downstream of the exhaust nozzle 20 in the direction of circulation of hot gases.

Consequently, the exhaust nozzle 20 is connected to the engine 6 in order to receive the hot gases leaving the engine 6. Moreover, the heat exchanger 40 is in fluid communication with the compressor 7 via at least one inlet pipe 101 and one outlet pipe 102 illustrated schematically. The compressed air is conveyed via an inlet pipe 101 into the heat exchanger 40, then heated by the hot gases before being directed to the combustion chamber 8 through at least one outlet pipe 102.

With reference to FIG. 2, the heat exchanger 40 may further be connected to an outlet nozzle 30 for discharging the hot gases.

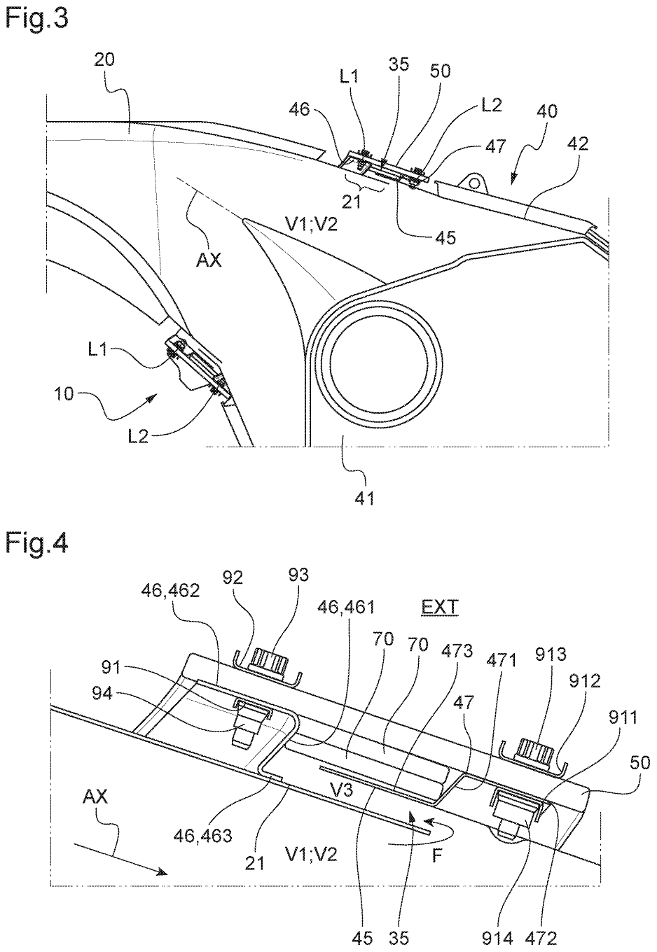

More precisely, and with reference to FIG. 3, the exhaust nozzle 20 extends from the engine 6 towards the heat exchanger 40 as far as an outlet end section 21 delimiting a first volume V1 through which the hot gases exhaust to reach the heat exchanger 40.

Similarly, the heat exchanger 40 comprises an inlet end section 45 delimiting a second volume V2 through which the hot gases penetrate into the heat exchanger 40.

The outlet end section 21 and the inlet end section 45 have a circular or polygonal shape according to the illustrated example, each extending 360 degrees around a longitudinal axis AX.

For example, the heat exchanger 40 comprises a casing 42 housing a plate heat exchange unit 41. This plate heat exchange unit 41 comprises hollow modules in fluid communication via the inlet 101 and outlet 102 pipes respectively with the compressor 7 and the combustion chamber 8 of the engine 6, the hot gases passing between the modules for example in countercurrent with respect to the compressed air.

Thus, the casing 42 may comprise the above-mentioned end inlet section 45.

With reference to the enlarged view of FIG. 4, the outlet end section 21 enters the inlet end section 45 in order to form a baffle 35 with respect to the hot gases coming from the exhaust nozzle 20. The inlet end section 45 is thus arranged to overlap the periphery of the outlet end section 21. In addition, a space V3 radially separates, with respect to the longitudinal axis AX, the outlet end section 21 and the inlet end section 45. The first volume V1 is thus at least partially inscribed in the second volume V2.

In order to exit the heat exchange assembly 10 between the exhaust nozzle 20 and the heat exchanger 40, the hot gases must then make a 180-degree turn in accordance with arrow F in order to penetrate into the space V3, and make another turn to exit from it. The baffle 35 therefore tends to limit the risks of leaks to the outside EXT.

In order to connect the exhaust nozzle 20 and the heat exchanger 40, reducing the risk of hot gases leaking while tolerating deformations of the exhaust nozzle 20 and the heat exchanger 40, the heat exchange assembly 10 comprises a multilayer cover strip 50 that covers the entire periphery of the baffle 35.

The multilayer cover strip 50 is secured to the exhaust nozzle 20 by a first angle bracket 46. For example, the first angle bracket 46 comprises a first central wall 461 secured to a first outer wall 462 secured to the multilayer cover strip 50, the first central wall 461 being able to be brazed to the exhaust nozzle 20 directly or via a first inner wall 463. Furthermore, the first bracket 46 may extend along a first closed line L1 around the longitudinal axis AX.

Similarly, the multilayer cover strip 50 is secured to the heat exchanger 40, and according to the example to the casing 42, via a second angle bracket 47. For example, the second angle bracket 47 comprises a second central wall 471 secured to a second outer wall 472 secured to the multilayer cover strip 50, the second central wall 471 being able to be brazed to the heat exchanger 40 directly or via a second inner wall 473. Furthermore, the second angle bracket 47 may extend along a second closed line L2 around said longitudinal axis AX.

The first angle bracket 46 and the second angle bracket 47 are longitudinally on either side of the baffle 35. This baffle 35 may, in particular, be delimited by the first and second central walls 461, 471.

According to the example in FIG. 4, the multilayer cover strip 50 is attached to the first angle bracket 46 and/or the second angle bracket 47 via a screwing device. Such a screwing device may comprise an inner back plate 91, 911 attached to the angle bracket 46, 47 concerned, and to an outer back plate 92, 912 attached to the multilayer cover strip 50, screws 93, 913 passing through the outer back plate 92, 912, then the multilayer cover strip 50, then the angle bracket 46, 47 concerned, and then the inner back plate 91, 911 concerned, in order to be screwed to nuts 94, 914.

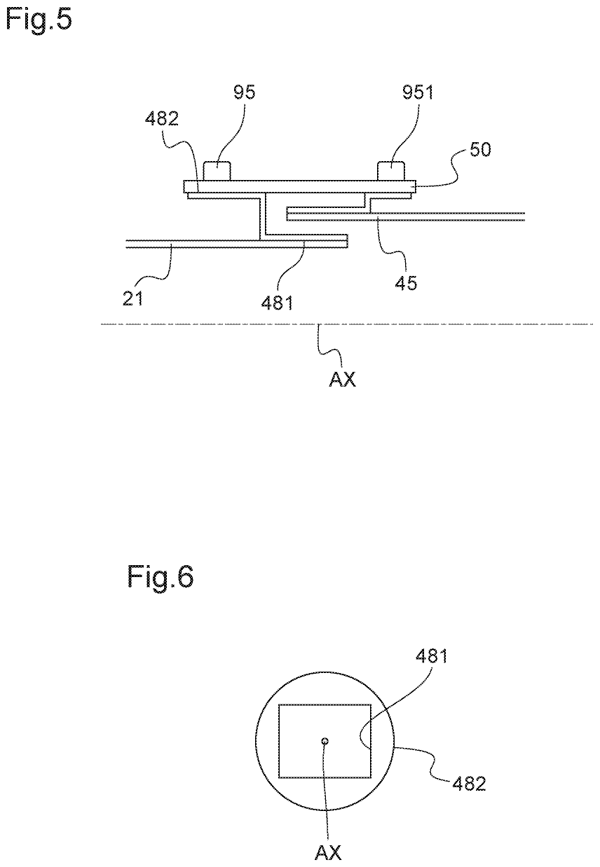

According to the example of FIG. 5, the multilayer cover strip 50 is attached to the first angle bracket 46 and/or the second angle bracket 47 using a clamping collar 95, 951.

With reference to FIG. 6, the attachment angle bracket 46 or 47 extends along a thickness from an inner face 481 to an outer face 482. In particular, in the presence of an exhaust nozzle 20 or a polygonal inlet end section 45 or polygonal outlet end section 21, the inner face 481 may describe a polygon and be attached to the exhaust nozzle 20 or to the heat exchanger 40, the outer face 482 being curved, i.e., substantially circular, in order to engage with a clamping collar 95, 951.

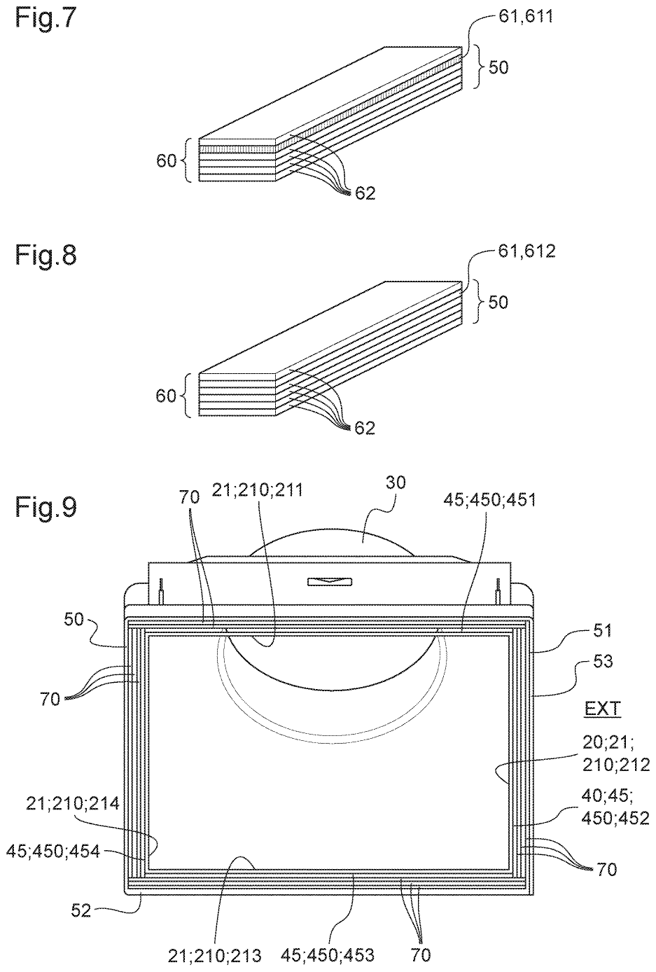

Furthermore, and with reference to FIG. 7 and FIG. 8, the multilayer cover strip 50 may comprise a stack 60 of layers. This stack 60 comprises a plurality of first layers 62 and a second layer 61. The stack 60 then rests on the first angle bracket 46 and the second angle bracket 47.

According to one possibility, each first layer 62 comprises silica, and, for example, a fabric comprising silica-based fibers, such as basalt or quartz.

By contrast, the second layer 61 is at least partially metallic. The second layer 61 comprises a metal mesh 611 according to the example of FIG. 7 or a metal sheet 612 according to the example of FIG. 8, the second layer 61 being made of aluminum alloy or stainless steel.

The second layer 61 may cover the first layers by representing the last layer of the stack 60 of the cover strip. Alternatively, and according to the illustrated examples, the second layer 61 may be encapsulated in the stack 60 of the cover strip by being arranged between two first layers 62, or even may be arranged in the penultimate position in the stack.

With reference to FIG. 9, the multilayer cover strip 50 may be partially wound on itself around the longitudinal axis AX. Thus, the multilayer cover strip 50 can extend along its largest dimension, namely its length, by successively comprising a first end region 51, a central region 52 and a second end region 53, the first end region 51 and the central region 52 each adjoining the first angle bracket 46 and to the second angle bracket 47, the second end region 53 resting on the first end region 51.

According to another aspect, the heat exchange assembly 10 may comprise at least one sealing strip 70. Each sealing strip 70 may be arranged longitudinally between the first angle bracket 46 and the second angle bracket 47, and in particular between the first central wall 461 and the second central wall 471, as shown in FIG. 4. Moreover, each sealing strip 70 may be arranged radially with respect to the longitudinal axis AX in a volume lying between the inlet end section 45 and the multilayer cover strip 50.

Each sealing strip 70 aims in particular to limit the risk of hot gases leaking to the outside EXT.

In the presence of polygonal sections 21, 45 as illustrated in FIG. 9, the output end section 21 and the input end section 45 may each have the same number of sides 210, 450, and four sides according to the example given.

Consequently, the heat exchange assembly 10 comprises at least one sealing strip 70 per side 210 of the inlet end section 45, at least one sealing strip 70 being arranged between each side 210 of the inlet end section 45 and the multilayer cover strip 50. Thus, according to the example, two sealing strips 70 are arranged between the side 451 and the multilayer cover strip 50, three sealing strips 70 are arranged between the side 452 and the multilayer cover strip 50, three sealing strips 70 are arranged between the side 453 and the multilayer cover strip 50, and three sealing strips 70 are arranged between the side 454 and the multilayer cover strip 50.

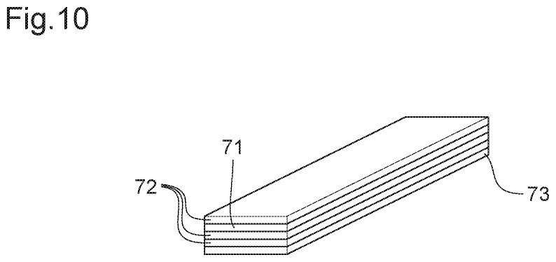

With reference to FIG. 10, each sealing strip 70 comprises a stack comprising insulating layers 72 comprising silica, this stack possibly comprising an additional layer 71 that is at least partially metallic. Optionally, at least one sealing strip 70 has such a stack comprising insulating layers 72 covering an inner layer 73 comprising vermiculite facing, or even in contact with, the inlet end section 45.

Each insulating layer 72 may comprise a fabric comprising silica, like the cover strip 50. Similarly, the optional additional layer may comprise a mesh or a metal sheet.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

What is claimed is:

1. A heat exchange assembly comprising an exhaust nozzle supplying hot gases to a heat exchanger, the exhaust nozzle extending to an outlet end section delimiting a first volume through which the hot gases exhaust to reach the heat exchanger, the heat exchanger comprising an inlet end section delimiting a second volume through which the hot gases penetrate into the heat exchanger, the outlet end section and the inlet end section extending 360 degrees around a longitudinal axis;
wherein the outlet end section enters the inlet end section in order to form a baffle with respect to the hot gases; a space radially separating the outlet end section and the inlet end section, the heat exchange assembly comprising a multilayer cover strip secured to a first angle bracket that is secured to the exhaust nozzle, the multilayer cover strip being secured to a second angle bracket that is secured to the heat exchanger, the multilayer cover strip surrounding the inlet end section and the outlet end section.

2. The heat exchange assembly according to claim 1,
wherein the multilayer cover strip is attached to at least one of the first angle bracket or second angle bracket by screws.

3. The heat exchange assembly according to claim 1,
wherein at least one clamping collar clamps the multilayer cover strip to at least one attachment angle bracket from the first angle bracket and second angle bracket.

4. The heat exchange assembly according to claim 3,
wherein the attachment bracket extends in a radial direction from an inner face to an outer face, the inner face describing a polygon and adjoining the exhaust nozzle or the heat exchanger, the outer face being curved and adjoining the clamping collar.

5. The heat exchange assembly according to claim 1,
wherein, the multilayer cover strip is wound on itself around the longitudinal axis.

6. The heat exchange assembly according to claim 1,
wherein the multilayer cover strip comprises a stack of layers comprising a plurality of first layers, the stack resting on the first angle bracket and the second angle bracket, each first layer comprising silica, the stack comprising a second layer that is at least partially metallic.

7. The heat exchange assembly according to claim 6,
wherein the second layer comprises a metal mesh or a metal sheet, the second layer being made of aluminum alloy or stainless steel.

8. The heat exchange assembly according to claim 6,
wherein the second layer is disposed between two first layers.

9. The heat exchange assembly according to claim 1,
wherein the first angle bracket extends along a first closed line around the longitudinal axis and the second angle bracket extends along a second closed line around the longitudinal axis.

10. The heat exchange assembly according to claim 1,
wherein the outlet end section and the inlet end section each have a polygonal shape.

11. The heat exchange assembly according to claim 1,
wherein the heat exchange assembly comprises at least one sealing strip arranged longitudinally between the first angle bracket and the second angle bracket, the at least one sealing strip being arranged radially with respect to the longitudinal axis in a volume lying between the inlet end section and the multilayer cover strip.

12. The heat exchange assembly according to claim 10,
wherein the outlet end section and the inlet end section each having a same number of sides, the heat exchange assembly comprises at least one sealing strip per side of the inlet end section, at least one sealing strip being arranged between each side of the inlet end section and the multilayer cover strip.

13. The heat exchange assembly according to claim 11,
wherein each sealing strip comprises a stack comprising insulating layers comprising silica, at least one sealing strip having a stack comprising insulating layers covering an inner layer comprising vermiculite facing the inlet end section.

14. The heat exchange assembly according to claim 1,
wherein the heat exchanger comprises a casing housing a plate heat exchange unit, the casing comprising the inlet end section.

15. A power plant comprising an engine provided with a compressor and a combustion chamber,
wherein the power plant comprises the heat exchange assembly according to claim 1, the exhaust nozzle being in fluid communication with the engine and receiving hot gases emitted by the combustion chamber, the heat exchanger being in fluid communication with the compressor to receive compressed air and to heat it using the hot gases before returning them to the combustion chamber.

16. An aircraft,
wherein the aircraft comprises the power plant according to claim 15.
